(19) United States
(12) Patent Application Publication
(10) Pub. No.: US 2010/0242337 A1
(43) Pub. Date: Sep. 30, 2010

(54) Ice fishing device

(76) Inventor: Steve Cummings, Burnsville, MN (US)

Correspondence Address: Mark A. Litman & Associates, P.A., York Business Center, 3209 West 76th St., Suite 205, Edina, MN, 55435, US

(21) Appl. No.: 12/384,020

(22) Filed: Mar. 30, 2009

(51) Int. Cl. A01K 97/01; A01K 97/00; A01K 85/01

(52) U.S. Cl. 43/17.5; 43/4.5

(57) ABSTRACT

An ice fishing hole lighting device has a solid frame with an opening within the frame having an average diameter of at least six inches. The frame has a top portion and a bottom portion, the bottom portion of the frame having a flat surface so as to lay against surfaces of ice, the bottom of the frame having between 2 and 12 high efficiency light emitting devices that emit light from the bottom portion of the frame without extending beyond the flat surface to interrupt contact between the flat surface and the ice surface. There are leads from the lights to a battery storage area, and a battery is in the battery storage area.

### BACKGROUND OF THE INVENTION

1. Field of the Invention

The present invention relates to the field of devices useful with ice fishing and particularly to ice fishing devices with lighting thereon.

2. Background of the Art

Ice fishing is a popular sport or recreation in Northern climates, especially in regions with lakes that can sustain fish populations when the water freezes over completely during Winter months. The sport is performed by cutting, drilling or augering a hole in the ice and then dropping a baited hook and line through the hole to attract and catch fish and retrieve them through the hole. The area around one or more holes may be enclosed within small structures called ice fishing houses, which may be only 3-10 feet in their widest dimensions. The structures protect the fishermen from winds and can moderate temperatures by retaining heat in the dwelling.

Numerous devices have been designed to enhance ice fishing and to make it more comfortable to the fisherman. The majority of devices have been designed to keep the hole from closing (by avoiding refreezing of water within the hole), for indicating a strike on the line and automatically triggering the line, and to signal an indication of a strike with some sort of alert or alarm.

Some ice fishing devices use lights as triggers for strikes (e.g., U.S. Pat. No. 7,343,708, Pieczynski; U.S. Pat. No. 6,097,424, Zernov, with lights on an underwater camera; and U.S. Pat. No. 6,408,561, Winter) or less frequently (U.S. Pat. No. 6,336.288, Foss) for lighting the lure.

There are other areas of technology in the recreational sport of ice fishing that can use additional technical advances to make the sport safer and more enjoyable.

### SUMMARY OF THE INVENTION

An ice fishing hole lighting device has a solid frame with an opening within the frame having an average diameter of at least six inches. The frame has a top portion and a bottom portion, the bottom portion of the frame having a flat surface so as to lay against surfaces of ice, the bottom of the frame having between 2 and 12 high efficiency light emitting devices that emit light from the bottom portion of the frame without extending beyond the flat surface to interrupt contact between the flat surface and the ice surface. There are leads from the lights to a battery storage area, and a battery is in the battery storage area.

### BRIEF DESCRIPTION OF THE FIGURES

FIG. 1 is a perspective drawing from the bottom of an ice fishing device according to technology herein disclosed.

### DETAILED DESCRIPTION OF THE INVENTION

One problem with ice fishing is that being performed in a closed environment away from significant power sources, it can be difficult for fishermen to focus on the ice hole and see a strike. The various prior art systems for having special devices on the rods or bobbers require purchase of unique fishing gear, while many ice fishermen have favorite poles, lures, bobbers and the like, which might not be compatible with the individual triggering systems. The proposed present technology can be used with essentially any existing poles, lures and bobbers.

The technology described herein may be generally characterized and specifically disclosed as an ice fishing hole lighting device. The device has a solid (rigid or flexible) frame having an opening within the frame, with an average diameter of at least six or at least eight inches. The frame has a top portion and a bottom portion, the bottom portion of the frame having a flat surface so as to lay against surfaces of ice. The bottom portion of the frame has between 2 and 12 high efficiency light emitting devices that emit light from the bottom portion of the frame. The light emitting devices do not extend significantly (e.g., more than 1 mm under the weight of the ice fishing device) beyond the flat surface, which would interrupt contact between the flat surface and the ice surface. There are electrical leads from the lights to a battery storage area, and a battery is placed in the battery storage area to power the lights. The high efficiency of the lights means that the lights should remain illuminated for at least one hour with a fresh pair of standard, 1.5V, AA batteries. Preferably the lights should stay illuminated at 80% of full light emission capacity for at least two hours. The high efficiency light emitting devices are preferably light emitting diodes. The ice fishing device may have posts rigidly attached to the frame that extend past the bottom of the frame to engage ice and secure the ice fishing device in a fixed position on the ice. The posts may be metal, polymeric, ceramic, composite or the like. Eye loops may extend away from the frame to assist in securing removable posts. The light emitting devices may be retained within cavities on the bottom portion of the frame. The cavity in the ice fishing device may be free of any cover over the cavity on the bottom portion of the frame, or a cover may be provided. A circuit switch may provide an on-off capability for the lights. For example, the circuit switch may be a pressure switch on the bottom portion of the frame so that when the ice fishing device is placed on a flat surface, the switch is closed, turning the light emitting devices on. At least portions of the frame around the cavity may be translucent or transparent to allow light to pass therethrough, and the frame may comprise synthetic polymeric material, wood, metal, composites or combinations thereof.

The present technology also discloses a method of ice fishing comprising opening a hole in ice over a body of water, placing the ice fishing device described above around the hole, dropping a fishing line through the opening in the ice fishing device and the hole in the ice, and illuminating the hole in the ice with the light emitting devices.

These and other elements of the present technology will be better understood by a review of the Figure.

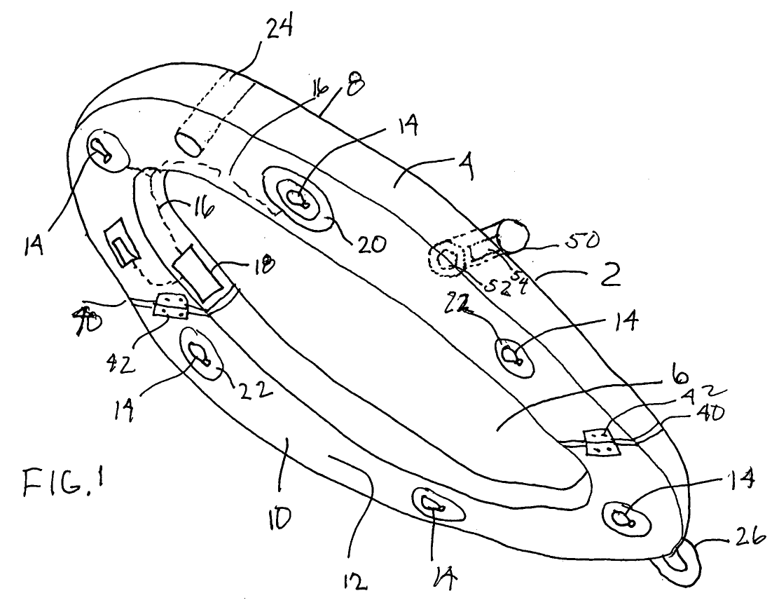

FIG. 1 shows a perspective view of an ice fishing device 2 according to the present technology. The device 2 has a solid (rigid or flexible) frame 4 having an opening 6 within the frame 4, with an average diameter of at least six or at least eight inches. The frame 4 has a top portion 8 and a bottom portion 10, the bottom portion 10 of the frame having a relatively flat surface 12 so as to lie against surfaces of ice (not shown). The bottom portion 10 of the frame 4 has between 2 and 12 high efficiency light emitting devices 14 that emit light from the bottom portion 10 of the frame 4. The light emitting devices 14 do not extend significantly (e.g., more than 1 mm under the weight of the ice fishing device) beyond the flat surface 12, which would interrupt contact between the flat surface 12 and the ice surface. There are electrical leads 16 from the lights to a battery storage area 18, and at least one battery (not shown) is placed in the battery storage area 18 to power the light emitting devices 14. A cover 20 or translucent/transparent region 20 around one lighting device 14 is shown. Light emitted from the lighting device 14 passes out of cavities 22, and where a surrounding area of the frame 4 is a transparent/translucent area 20, light will also pass through this area 20. This emitted light will illuminate the hole (not shown) around the edges and into the hole, and will assist the fisherman in viewing the hole and activity within the hole (e.g., a bobber or the line). A post hole 24 is shown, through which a post may be embedded into the ice. A side loop 26 for receiving a similar post or spike (not shown) is shown in FIG. 1 as an alternative. The lights will illuminate ice around the hole and at least part of a volume within the hole (e.g., the top of the water).

The frame 4 is shown with a folding capability to reduce the size of the device during transport. Opposed gaps 40 in the frame 4 are provided with hinges 42 so that the frame can fold at least once to reduce at least one diameter dimension. More than one fold may be available.

The frame may also be provided with a separate light system 50 having a bulb or LED 52 emitting towards the opening 6 of the device 2 and a separate battery or it may be connected to the battery 18 for the underlying lights 14. Instead of the translucent/transparent area 20, washers may be provided to protect the bulbs 14. The washers may be flush with the base 12 or may be elevated. The elevated washers (which nay be present in place of the translucent/transparent areas 20) may actually assist in the steadying of the device 2 against the ice, as the extension of the washers may engage rough spots in the ice around the hole.

The frame 4 may be continuous or may have a slot from an outside edge to the hole without interrupting the function of the device. These and other variations and alternatives can be practiced by the skilled artisan without losing the generic scope of the present technology.

What is claimed:

1. An ice fishing hole lighting device comprising: a solid frame having an opening within the frame having an average diameter of at least six inches, the frame having a top portion and a bottom portion, the bottom portion of the frame having a flat surface so as to lay against surfaces of ice, the bottom of the frame having between 2 and 12 high efficiency light emitting devices that emit light from the bottom portion of the frame without extending beyond the flat surface to interrupt contact between the flat surface and the ice surface, leads from the lights to a battery storage area, and a battery in the battery storage area.

2. The ice fishing device of claim 1 wherein the high efficiency light emitting devices comprise light emitting diodes.

3. The ice fishing device of claim 1 having posts rigidly attached to the frame that extend past the bottom of the frame to engage ice and secure the ice fishing device in a fixed position on the ice.

4. The ice fishing device of claim 1 wherein the light emitting devices are retained within cavities on the bottom portion of the frame.

5. The ice fishing device of claim 4 wherein the cavity is free of any cover over the cavity on the bottom portion of the frame.

6. The ice fishing device of claim 4 wherein the cavity has a partial cover over the cavity on the bottom portion of the frame.

7. The ice fishing device of claim 1 wherein a circuit switch provides an on-off capability for the lights.

8. The ice fishing device of claim 7, wherein the circuit switch is a pressure switch on the bottom portion of the frame so that when the ice fishing device is placed on a flat surface, the switch is closed, turning the light emitting devices on.

9. The ice fishing device of claim 4 wherein at least one additional light is present on the top portion of the device, and that light is directed towards the opening.

10. The ice fishing device of claim 4 wherein the frame comprises synthetic polymeric material.

11. A method of ice fishing comprising opening a hole in ice over a body of water, placing the ice fishing device of claim 1 around the hole, dropping a fishing line through the opening in the ice fishing device and the hole in the ice, and illuminating ice around the hole and at least part of a volume within the hole in the ice with the light emitting devices.

12. A method of ice fishing comprising opening a hole in ice over a body of water, placing the ice fishing device of claim 2 around the hole, dropping a fishing line through the opening in the ice fishing device and the hole in the ice, and illuminating ice around the hole and at least part of a volume within the hole in the ice with the light emitting devices.

13. A method of ice fishing comprising opening a hole in ice over a body of water, placing the ice fishing device of claim 3 around the hole, dropping a fishing line through the opening in the ice fishing device and the hole in the ice, and illuminating ice around the hole and at least part of a volume within the hole in the ice with the light emitting devices.

14. A method of ice fishing comprising opening a hole in ice over a body of water, placing the ice fishing device of claim 4 around the hole, dropping a fishing line through the opening in the ice fishing device and the hole in the ice, and illuminating ice around the hole and at least part of a volume within the hole in the ice with the light emitting devices.

15. A method of ice fishing comprising opening a hole in ice over a body of water, placing the ice fishing device of claim 5 around the hole, dropping a fishing line through the opening in the ice fishing device and the hole in the ice, and illuminating ice around the hole and at least part of a volume within the hole in the ice with the light emitting devices.

16. A method of ice fishing comprising opening a hole in ice over a body of water, placing the ice fishing device of claim 7 around the hole, dropping a fishing line through the opening in the ice fishing device and the hole in the ice, and illuminating ice around the hole and at least part of a volume within the hole in the ice with the light emitting devices.

17. A method of ice fishing comprising opening a hole in ice over a body of water, placing the ice fishing device of claim 7 around the hole, dropping a fishing line through the opening in the ice fishing device and the hole in the ice, and illuminating ice around the hole and at least part of a volume within the hole in the ice with the light emitting devices.

18. A method of ice fishing comprising opening a hole in ice over a body of water, placing the ice fishing device of claim 8 around the hole, dropping a fishing line through the opening in the ice fishing device and the hole in the ice, and illuminating ice around the hole and at least part of a volume within the hole in the ice with the light emitting devices.

19. A method of ice fishing comprising opening a hole in ice over a body of water, placing the ice fishing device of claim 9 around the hole, dropping a fishing line through the opening in the ice fishing device and the hole in the ice, and illuminating ice around the hole and at least part of a volume within the hole in the ice with the light emitting devices.

20. A method of ice fishing comprising opening a hole in ice over a body of water, placing the ice fishing device of claim 10 around the hole, dropping a fishing line through the opening in the ice fishing device and the hole in the ice, and illuminating ice around the hole and at least part of a volume within the hole in the ice with the light emitting devices.
